(19) United States
(12) Patent Application Publication
(10) Pub. No.: US 2009/0170572 A1
(43) Pub. Date: Jul. 2, 2009

(54) HINGE MODULE AND PORTABLE TERMINAL HAVING THE SAME

(75) Inventor: Gyu Jin KWON, Suwon (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/272,057

(22) Filed: Nov. 17, 2008

(30) Foreign Application Priority Data
Dec. 27, 2007 (KR) 10-2007-0138454

(51) Int. Cl. H04M 1/00

(52) U.S. Cl. 455/575.3

(57) ABSTRACT

Disclosed are a hinge module for rotating and opening a folder or horizontally sliding and opening the folder, and a portable terminal having the same. In a portable terminal, a body and a folder are connected by a hinge module. The hinge module includes a fixing unit, a guide rod, and a guide. The fixing unit is fixed to the body. A first end of the guide rod is fixed to the fixing unit and a second end of the guide rod extends into the folder. The guide is fixed to the folder. The guide is coupled to the guide rod in the folder so as to be horizontally movable along the guide rod to slide the folder and rotatable about the guide rod to rotate the folder.

### CROSS REFERENCE TO RELATED APPLICATION

This application claims priority from and the benefit of Korean Patent Application No. 10-2007-0138454, filed on Dec. 27, 2007, which is hereby incorporated by reference for all purposes as if fully set forth herein.

### BACKGROUND OF THE INVENTION

1. Field of the Invention

The present invention relates generally to a hinge module and a portable terminal having the same and, more particularly, to a hinge module capable of opening a folder by rotating the folder or horizontally sliding the folder, and a portable terminal having the same.

2. Discussion of the Background

Due to development of information communication technologies and technologies for manufacturing portable terminals, various types of portable terminals that can execute various applications and be easily carried are being introduced. Such portable terminals may be classified as bar type terminals, flip type terminals, folder type terminals, or slide type terminals.

In a conventional folder type or slide type portable terminal, a folder and a body are connected to each other by a hinge module. The conventional folder type or slide type portable terminal may be opened by rotating the folder upward or sliding the folder with respect to the body. By opening the folder, a display provided on a front or rear surface of the folder may be activated to display an image and a keypad provided on a front surface of the body may be exposed.

In addition, the user may open the folder in a longitudinal direction of the display to perform a communication mode such as voice communication mode, and may open folder in a transverse direction of the display to perform a multimedia mode such as a game mode, a mobile broadcasting mode, a movie mode, or a photo appreciation mode.

As mentioned above, since the conventional portable terminal may separately perform an operation of opening the folder and an operation of rotating the folder according to its mode, it may be inconvenient to use.

In addition, since the keypad may be located on the right side of the display when the folder is opened in the longitudinal direction, it may be inconvenient to manipulate.

### SUMMARY OF THE INVENTION

The present invention provides a hinge module that may be operated as both a folder type and a sliding type, and a portable terminal having the same.

The present invention also provides a hinge module that may make manipulation of a portable terminal more convenient, and a portable terminal having the same.

The present invention also provides a portable terminal that may enable a display to display an image transversely or longitudinally according to the direction in which a folder is opened.

The present invention also provides a hinge module that may enable a user to conveniently use a dual display of a portable terminal, and a portable terminal having the same.

Additional features of the invention will be set forth in the description which follows, and in part will be apparent from the description, or may be learned by practice of the invention.

The present invention discloses a hinge module of a portable terminal that connects a body and a folder. The hinge module includes a fixing unit, a guide rod, and a guide. The fixing unit is fixed to the body. A first end of the guide rod is fixed to the fixing unit and a second end of the guide rod extends into the folder. The guide is fixed to the folder. The guide is coupled to the guide rod in the folder so as to be horizontally movable along the guide rod to slide the folder and rotatable about the guide rod to rotate the folder.

The present invention also discloses a portable terminal including a folder, a body, and a hinge module. The folder has a display on at least one of a front surface and a rear surface thereof. The body has an input unit installed on a front surface thereof. The hinge module connects the body and the folder. The hinge module includes a fixing unit, a guide rod, and a guide. The fixing unit is fixed to the body. A first end of the guide rod is fixed to the fixing unit and a second end of the guide rod extends into the folder. The guide is fixed to the folder. The guide is coupled to the guide rod in the folder so as to be horizontally movable along the guide rod to slide the folder and rotatable about the guide rod to rotate the folder.

The present invention also discloses a hinge module of a portable terminal including a fixing unit, a guide rod having a first end fixed to the fixing unit, and a guide coupled to a second end of the guide rod so as to be horizontally movable along the guide rod and rotatable about the guide rod.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a portable terminal according to an exemplary embodiment of the present invention.

FIG. 2 is a perspective view showing an assembled state of the portable terminal of FIG. 1.

FIG. 3 is a perspective view showing the hinge module of FIG. 2.

FIG. 4 is a view showing a state of the portable terminal of FIG. 2 in which a folder is rotated.

FIG. 5 and FIG. 6 are views showing a state of the portable terminal of FIG. 2 in which the folder is slid.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Hereinafter, exemplary embodiments of the present invention will be described in detail with reference to the accompanying drawings.

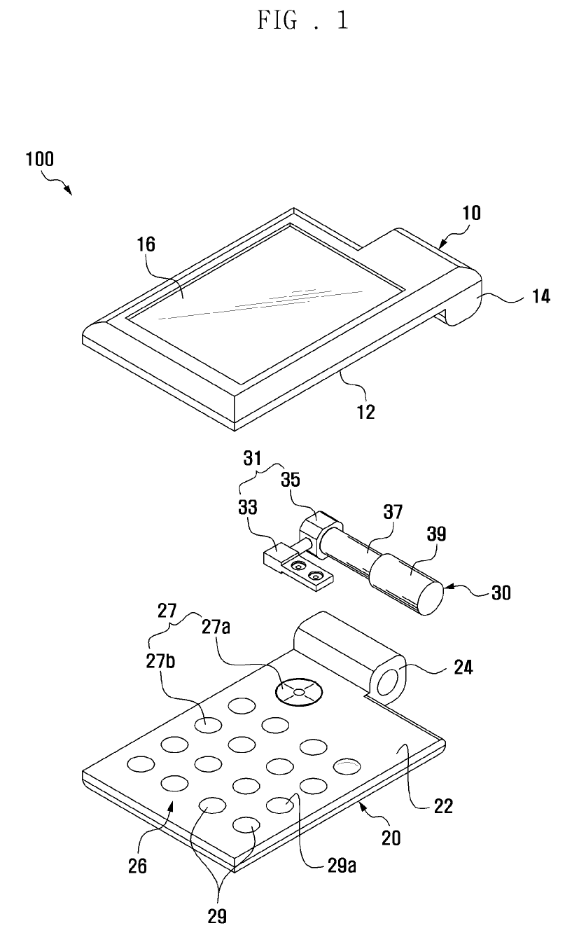

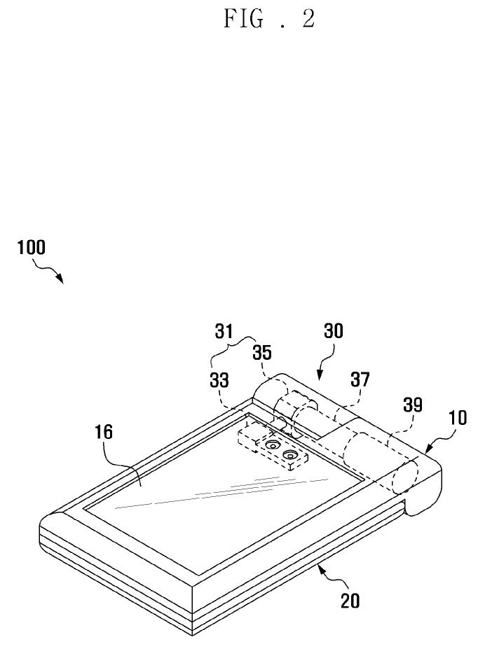

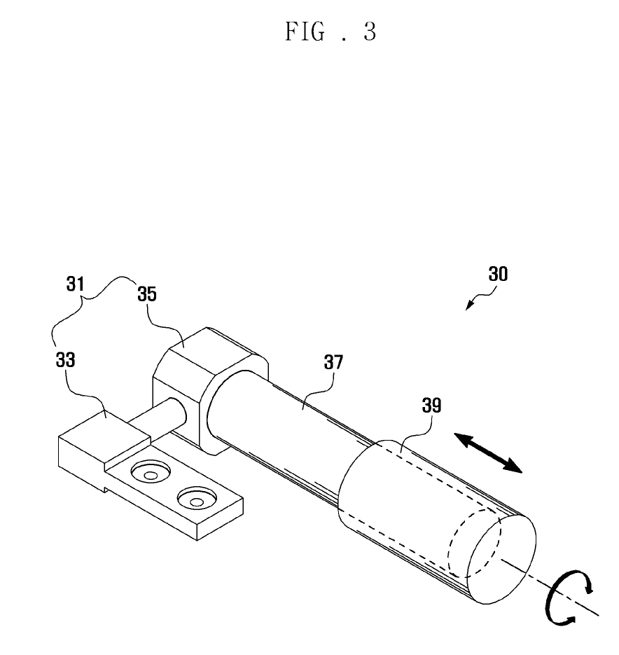

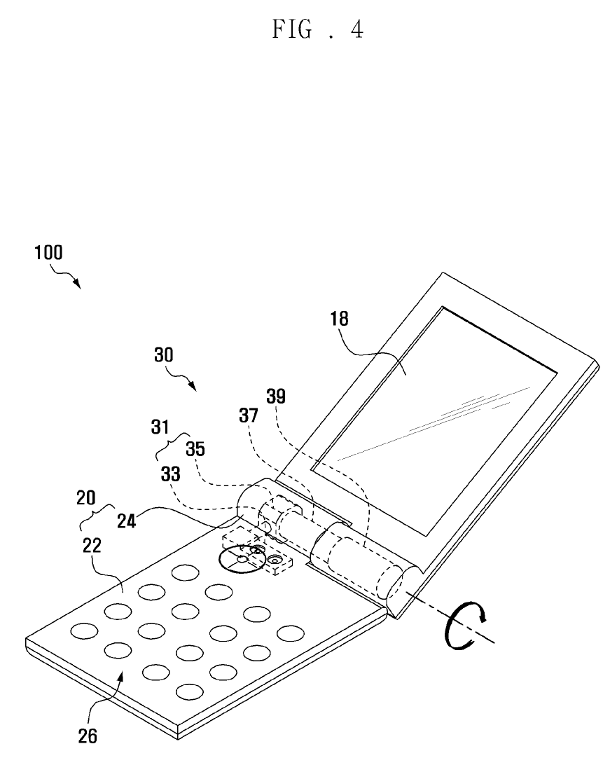

Referring to FIG. 1, FIG. 2, FIG. 3, and FIG. 4, a portable terminal 100 according to an exemplary embodiment of the present invention includes a folder 10, a body 20, and a hinge module 30. Ends of the folder 10 and the body 20 are connected to each other by the hinge module 30.

In particular, the hinge module 30 includes a fixing unit 31, a guide rod 37, and a guide 39. The fixing unit 31 is fixed to the body 20. The guide rod 37 has a first end fixed to the fixing unit 31 and a second end extending into the folder 10. The guide 39 is fixed to the body 20 and coupled to the guide rod 37 inside the folder 10 so that it is horizontally movable along the guide rod 37 to slide the folder 10 or rotatable about the guide rod 37 to rotate the folder 10. The fixing unit 31 includes a first fixed portion 33 and a second fixed portion 35. The first fixed portion 33 is fixed to the body 20. The second fixed portion 35 is connected to the first fixed portion 33 to fix the guide rod 37 inside the body 20.

Accordingly, the portable terminal 100 according to the exemplary embodiment of the present invention may be used by horizontally pushing and sliding the folder 10 with respect to the body 20 or by rotating the folder 10. In other words, the portable terminal 100 according to an exemplary embodiment of the present invention may be used in folder type mode or a slide type mode according to the direction in which the folder is opened.

Hereinafter, the portable terminal 100 according to an exemplary embodiment of the present invention will be described in more detail.

The folder 10 includes a first mount 12 and a first connector 14. First and second displays 16 and 18 are installed on opposite surfaces of the first mount 12. The first connector 14 protrudes from one side of the first mount 12, and the guide 39 is fixed inside the first connector 14. The first display 16 is installed on the front surface of the first mount 12, and the second display 18 is installed on the rear surface of the first mount 12.

The first and second displays 16 and 18 may each be a liquid crystal display (LCDs) or an active matrix organic light emitting diode (AM OLED). The first and second displays 16 and 18 are arranged on the front and rear surfaces of the first mount 12 in rectangular shapes respectively, and short edges of the first and second displays 16 and 18 are arranged parallel to the guide rod 37. The first and second displays 16 and 18 have the same size in this exemplary embodiment of the present invention, but the present invention is not limited thereto. In other words, the first and second displays 16 and 18 may have different sizes.

The body 20 includes a second mount 22 and a second connector 24. An input unit 26 is installed on a front surface of the mount 22, and the first fixing unit 33 is fixed to the second mount 22. The second connector 24 protrudes from one side of the second mount 22 and contacts one surface of the first connector 14, and the second fixing unit 35 is fixed to the second connector 24. Accordingly, the first and second connectors 14 and 24 face each other.

The input unit 26 is provided to manipulate the portable terminal 100, and includes direction keys 27a, number/letter keys 27b and 29a, and function keys. In addition, the first and second display units 16 and 18 may be touch screens.

The guide rod 37 of the hinge module 30 is disposed in the first and second connectors 14 and 24.

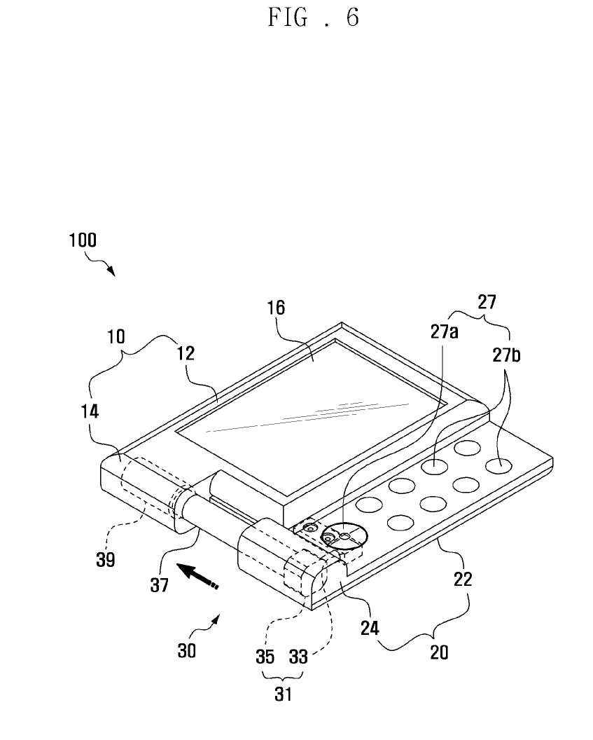

The guide 39 of the hinge module 30 may move horizontally along the guide rod 37 to slide the folder 10. Accordingly, when the guide 39 fixed to the folder 10 is horizontally moved along the guide rod 37, the folder 10 slides with respect to the body 20 as shown in FIG. 6.

Since the guide rod 37 is fixed to the body 20 by the second fixing unit 35 and the guide 39 is fixed to the first connector 14 and engaged with the guide rod 37 so as to be rotatable about the guide rod 37, the folder 10 may be rotated with respect to the body 20. In other words, when the guide 39 fixed to the folder 10 rotates around the guide rod 37, the folder 10 rotates with respect to the body 20 as shown in FIG. 4.

Meanwhile, the first connector 14 protrudes with respect to the rear surface of the folder 10, so that the first and second connectors 14 and 24 are connected to each other through the medium of the guide rod 37 of the hinge module 30. The second connector 24 protrudes with respect to the front surface of the body 20. The distance by which the first connector 14 protrudes from the rear surface of the folder 10 may correspond to the thickness of the second mount 22, and the distance by which the second connector 24 protrudes from the front surface of the body 20 may correspond to the thickness of the first mount 12. The outer surfaces of the first and second connectors 14 and 24 may be streamlined so that the folder 10 may smoothly rotate with respect to the body 20.

The input unit 26 installed on the front surface of the body 20 may include a first input unit 27 and a second input unit 29. The first input unit 27 is installed on a front surface portion of the body 20 that is exposed when the folder 10 is opened. The second input unit 29 is installed on a front surface portion of the body 20 that is covered by the folder 10 when the folder 10 is opened. The first input unit 27 includes direction keys 27a and a first keypad 27b, and the second input unit 29 includes a second keypad 29a. The direction keys 27a may include at least one of a keypad, a touchpad, a scroll wheel, and a joystick. The first and second keypads 27b and 29a may be combined to constitute number/letter keys, and may further include function keys.

When the folder 10 slides, the user may use the first input unit 27. On the other hand, when the folder 10 rotates, the user may use the both of the first and second input units 27 and 29.

The guide 39 of the hinge module 30 is fixed to the folder 10 and the fixing unit 31 is fixed to in the body 20 in this exemplary embodiment of the present invention, but the present invention is not limited thereto. In other words, the guide 39 of the hinge module 20 may be fixed to the body 20 and the fixing unit 31 may be fixed to the folder 10.

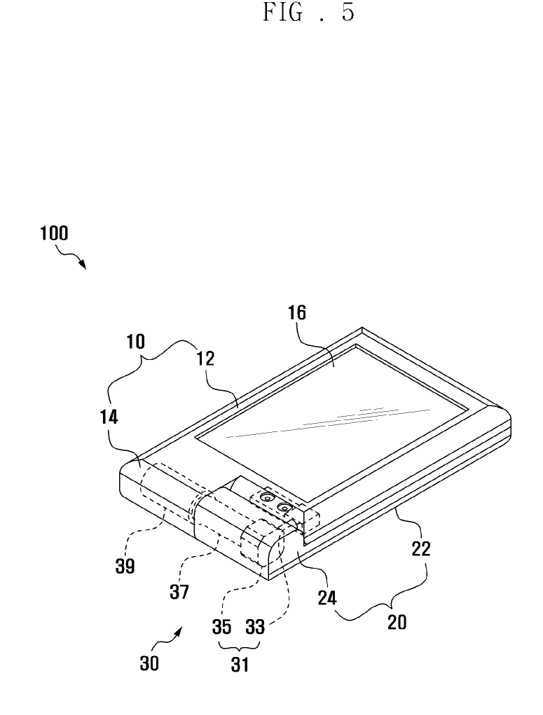

Hereinafter, the usage of the portable terminal 100 according to an exemplary embodiment of the present invention will be described in detail with reference to FIG. 2, FIG. 4, FIG. 5, and FIG. 6.

As shown in FIG. 2 and FIG. 4, the portable terminal 100 according to an exemplary embodiment of the present invention may be used as a folder type portable terminal by rotating the folder 10. In other words, as shown in FIG. 2, the folder 10 may overlap the body 20 such that the first display 16 is longitudinally disposed. The first and second connectors 14 and 24 are located on the upper side. Thereafter, as shown in FIG. 4, if the folder 10 is rotated with respect to the body 20, the guide 39 rotates about the guide rod 37. In other words, since the guide rod 37 is fixed to the body 20 by the second fixing unit 35, and the guide 39 is fixed to the first connector 14 and coupled to the guide rod 37 so that it may be rotated about the guide rod 37, the folder 10 may be rotated with respect to the body 20.

Then, the second display 18 is activated by the rotation of the folder 10, and the input unit 26 is exposed. Accordingly, the user may rotate the folder 10 to longitudinally use the second display 18. In other words, a communication mode such as voice communication may be performed through the second display 18 of the rotated folder 10. The exposed input unit 26 may be used as an input unit during the communication mode.

As shown in FIG. 5 and FIG. 6, the portable terminal 100 according to exemplary embodiments of the present invention may be used as a slide type portable terminal by sliding the folder 10 with respect to the body 20. In other words, as shown in FIG. 5, the folder 10 may overlap the body 20 such that the first display 16 is transversely disposed. The first and second connectors 14 and 24 may be located on the left side, and the first connector 14 may be located above the second connector 24. Thereafter, if the folder 10 is pushed upward with respect to the body 10, the guide 39 moves upward along the guide rod 37 so that the folder 10 slides upward with respect to the body 20. In other words, since the guide rod 37 is fixed to the body 20 by the second fixing unit 35, and the guide 39 is fixed to the first connector 14 and coupled to the guide rod 37 such that it may horizontally move along the guide rod 37, the folder 10 slides with respect to the body 20 when it is pushed.

When the folder 10 slides, the interval between the first connector 14 and the second connector 24 is increased and the guide rod 37 in the first connector 14 is exposed. Moreover, the first display 16 is activated and the first input unit 27 below the folder 10 is exposed.

Accordingly, the user may slide the folder 10 to transversely use the first display 27. In other words, the user may perform a multimedia mode such as a game mode, a mobile broadcasting mode, a movie mode, or a photo appreciation mode. The first input unit 27 may be used as an input unit during the multimedia mode.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A hinge module of a portable terminal that connects a body and a folder, the hinge module comprising:
a fixing unit fixed to the body;
a guide rod comprising a first end fixed to the fixing unit and a second end that extends into the folder; and
a guide fixed to the folder, the guide being coupled to the guide rod in the folder so as to be horizontally movable along the guide rod to slide the folder and rotatable about the guide rod to rotate the folder.

2. The hinge module of claim 1, wherein the fixing unit comprises:
a first fixed portion fixed to the body; and
a second fixed portion connected to the first fixed portion, the second fixed portion to fix the guide rod inside the body.

3. A portable terminal, comprising:
a folder comprising a display on at least one of a front surface and a rear surface thereof,
a body comprising an input unit installed on a front surface thereof, and
a hinge module connecting the body and the folder,
wherein the hinge module comprises:
a fixing unit fixed to the body;
a guide rod comprising a first end fixed to the fixing unit and a second end that extends into the folder; and
a guide fixed to the folder, the guide being coupled to the guide rod in the folder so as to be horizontally movable along the guide rod to slide the folder and rotatable about the guide rod to rotate the folder.

4. The portable terminal of claim 3, wherein the fixing unit comprises:
a first fixed portion fixed to the body; and
a second fixed portion connected to the first fixed portion, the second fixed portion to fix the guide rod inside the body.

5. The portable terminal of claim 4, wherein the folder comprises:
a first mount on which the display is installed; and
a first connector protruding from the first mount, the guide being fixed to the first connector, and
the body comprises:
a second mount on which the input unit is installed and to which the first fixed portion is fixed; and
a second connector protruding from the second mount and contacting an end surface of the first connector, the second fixed portion being fixed to the end surface of the second connector.

6. The portable terminal of claim 5, wherein the guide rod is disposed in the first connector and the second connector.

7. The portable terminal of claim 6, wherein the display comprises:
a first display installed on a front surface of the first mount; and
a second display installed on a rear surface of the first mount.

8. The portable terminal of claim 7, wherein the first display is activated when the folder moves horizontally along the guide rod with the folder overlapping the body.

9. The portable terminal of claim 8, wherein the second display is activated when the folder rotates about the guide rod with the folder overlapping the body.

10. The portable terminal of claim 9, wherein the input unit comprises:
a first input unit installed at a portion of the body that is exposed when the folder moves horizontally along the guide rod; and
a second input unit installed at a portion of the body that is covered when the first input unit is exposed.

11. The portable terminal of claim 10, wherein the first input unit comprises direction keys and a first keypad.

12. The portable terminal of claim 11, wherein the second input unit comprises a second keypad, and the first keypad and the second keypad are combined with each other to constitute number/letter keys.

13. The portable terminal of claim 12, wherein the first display and the second display are installed on the front surface and the rear surface of the first mount in rectangular shapes, respectively, and short edges of the first display and the second display are disposed parallel to the guide rod.

14. The portable terminal of claim 13, wherein the first display and the second display are the same size.

15. A hinge module of a portable terminal, comprising:
a fixing unit;
a guide rod comprising a first end fixed to the fixing unit; and
a guide coupled to a second end of the guide rod so as to be horizontally movable along the guide rod and rotatable about the guide rod.
